(19) United States
(12) Patent Application Publication
(10) Pub. No.: US 2005/0116888 A1
(43) Pub. Date: Jun. 2, 2005

(54) Panel driving method, panel driving apparatus, and display panel

(76) Inventors: Jin-Sung Kim, Cheonan-si (KR); Woo-Joon Chung, Asan-si (KR); Seung-Hun Chae, Suwon-si (KR); Kyoung-Ho Kang, Suwon-si (KR); Tae-Seong Kim, Asan-si (KR)

Correspondence Address: Robert E. Bushnell;Suite 300, 1522 K. Street, N.W., Washington, DC, 20005-1202, US

(21) Appl. No.: 10/965,286

(22) Filed: Oct. 15, 2004

(30) Foreign Application Priority Data
Oct. 17, 2003 (KR) 2003-72508

(51) Int. Cl. G09G 3/28

(52) U.S. Cl. 345/60

(57) ABSTRACT

A panel driving method for driving a display panel having a progressive scanning electrode structure includes determining an image output mode, driving the display panel by progressive scanning in a first mode, and driving the display panel by interlaced scanning in a second mode. In a display panel having a progressive scanning electrode structure, progressive scanning is used to embody high definition, or interlaced scanning is used to embody high luminance, according to a desired image output mode. A panel driving apparatus comprises a scanning pulse generator applying the same address pulse to pairs of scan electrodes, a first sustain pulse generator for applying main sustain pulses to a first group of scan electrodes, and a second sustain pulse generator for applying subsidiary sustain pulses to a second group of scan electrodes.

### CLAIM OF PRIORITY

This application makes reference to, incorporates the same herein, and claims all benefits accruing under 35 U.S.C. §119 from my application PANEL DRIVING METHOD, PANEL DRIVING APPARATUS, AND DISPLAY PANEL filed with the Korean Industrial Property Office on Oct. 17, 2003 and there duly assigned Serial No. No. 2003-72508.

### BACKGROUND OF THE INVENTION

1. Technical Field

The present invention relates to technology for driving a panel such as a plasma display panel (PDP) and, more particularly, to a panel driving method for displaying a picture by applying a sustain pulse to an electrode structure forming a display cell, such as a PDP.

2. Related Art

In a typical surface discharge type triode PDP, address electrode lines, dielectric layers, Y-electrode lines, X-electrode lines, phosphor layers, barrier walls, and a protective layer, such as a magnesium oxide (MgO) layer, are provided between a front glass substrate and a rear glass substrate of the surface discharge PDP.

The address electrode lines are formed on the front surface of the rear glass substrate in a predetermined pattern. A rear dielectric layer is formed on the surface of the rear glass substrate having the address electrode lines. The barrier walls are formed on the front surface of the rear dielectric layer parallel to the address electrode lines. The barrier walls partition discharge regions of respective display cells and serve to prevent cross talk between display cells. The phosphor layers are formed between the barrier walls.

The X-electrode lines and the Y-electrode lines are formed on the rear surface of the front glass substrate in a predetermined pattern so as to be orthogonal to the address electrode lines. The respective intersections define display cells. Each of the X-electrode lines may include a transparent electrode line formed of a transparent conductive material, e.g., indium tin oxide (ITO), and a metal electrode line for increasing conductivity. Each of the Y-electrode lines may include a transparent electrode line formed of a transparent conductive material, e.g., indium tin oxide (ITO), and a metal electrode line Y_{nb} for increasing conductivity. A front dielectric layer is deposited on the entire rear surface of the front glass substrate having the X-electrode lines and the Y-electrode lines formed on its rear surface. The protective layer, e.g., a MgO layer, for protecting the panel against a strong electrical field, is deposited on the entire rear surface of the front dielectric layer. A gas for forming plasma is hermetically sealed in a discharge space.

In driving such a PDP, usually, a reset step, an address step, and a sustain step are sequentially performed in each subfield. In the reset step, charges are made uniform in display cells to be driven. In the address step, a charge state of display cells to be selected and a charge state of display cells to be unselected are set up. In the sustain step, a display discharge is performed in the display cells to be selected. In the latter regard, plasma is produced from the plasma forming gas in the display cells where the display discharge is performed. The plasma emits ultraviolet rays exciting the phosphor layers in the display cells so that light is emitted.

An address-display separation driving method for a PDP having such a structure is disclosed in U.S. Pat. No. 5,541,618.

A typical driving apparatus for the PDP includes an image processor, a logic controller, an address driver, an X-driver, and a Y-driver The image processor converts an external analog image signal into a digital signal to generate an internal image signal, for example, 8-bit red (R) video data, 8-bit green (G) video data, and 8-bit blue (B) video data, a clock signal, a vertical synchronizing signal, and a horizontal synchronizing signal. The logic controller generates drive control signals in response to the internal image signals from the image processor. The address driving unit processes an address signal among the drive control signals output from the logic controller to generate a display data signal, and applies the display data signal to address electrode lines. The X-driver processes the X-drive control signal S_{X} among the drive control signals output from the logic controller, and applies the result of processing to X-electrode lines. The Y-driver processes the Y-drive control signal among the drive control signals output from the logic controller, and applies the result of processing to Y-electrode lines.

With respect to a typical address-display separation driving method, to realize time-division grayscale display, a unit frame may be divided into a predetermined number of subfields. In addition, the individual subfields are composed of reset periods, address periods, and sustain periods, respectively.

During each of the address periods, display data signals are applied to address electrode lines simultaneously, and a scan pulse is sequentially applied to the Y-electrode lines.

During each of the sustain periods, a pulse for display discharge is alternately applied to the Y-electrode lines and the X-electrode lines, thereby provoking display discharge in discharge cells in which wall charges are induced during each of the address periods.

The luminance of the PDP is proportional to a total length of the sustain periods in a unit frame. When a unit frame forming a single image is expressed by 8 subfields and 256 grayscales, different numbers of sustain pulses may be allocated to the respective subfields at a ratio of 1:2:4:8:16:32:64:128. Luminance corresponding to 133 grayscales can be obtained by addressing cells and sustaining a discharge during a first subfield, a third subfield, and an eighth subfield.

A sustain period allocated to each subfield can be variably determined depending upon weights, which are applied to the respective subfields according to an automatic power control (APC) level, and can be variously changed taking account of gamma characteristics or panel characteristics. For example, a grayscale level allocated to a fourth subfield can be lowered from 8 to 6, while a grayscale level allocated to a sixth subfield can be increased from 32 to 34. In addition, the number of subfields constituting a single frame can be variously changed according to design specifications.

With respect to driving signals used in the PDP, a single subfield includes a reset period, an address period, and a sustain period.

During the reset period, a reset pulse is applied to all of the scan electrodes, thereby initializing a state of wall charges in each cell. The reset period is performed before entering the address period. The reset period is provided prior to the address period. Since the initialization is performed throughout the during the reset period, a highly uniform and desirable distribution of wall charges can be obtained. The cells initialized during the reset period have wall charge conditions similar to one another. The reset period is followed by the address period. During the address period, a bias voltage is applied to the common electrodes and the scan electrodes and the address electrodes corresponding to cells to be displayed are simultaneously turned on to select the cells. After the address period, a sustain pulse is alternately applied to the common electrodes and the scan electrodes during the sustain period. During the sustain period, a voltage of a low level is applied to the address electrodes.

In a PDP, luminance is adjusted by the number of sustain pulses. As the number of sustain pulses in a single subfield or TV field increases, the luminance also increases. Thus, a time period taken for a sustain period should be lengthened in order to increase the luminance. However, since a period of a first TV field is fixed to, for example, 60 Hz and 16.67 ms, in driving the PDP, the reset period and the address period should be shortened or the subfield should be reduced in order to increase the sustain period.

The time taken for an address operation significantly affects the high definition of a PDP. In other words, address times are allocated to respective scan lines. A PDP of a higher definition requires a greater number of scan lines. Then, when the address speed is constant, the address time is increased in proportion to the number of scan lines. Consequently, the period for allocating a sustain discharge in a fixed TV field is reduced.

### SUMMARY OF THE INVENTION

The present invention provides a panel driving method and a display panel, each of which embodies interlaced scanning in a progressive scanning electrode structure.

The present invention also provides a panel driving apparatus which can select progressive scanning or interlaced scanning according to an image mode in a progressive scanning electrode structure.

According to an aspect of the present invention, there is provided a panel driving method for driving a display panel having a progressive scanning electrode structure. The panel driving method comprises the steps of: determining an image output mode; driving the display panel by progressive scanning when the image output mode is a first mode; and driving the display panel by interlaced scanning when the image output mode is a second mode. Herein, the first mode may be a monitor mode, and the second mode may be a moving picture mode.

The interlaced scanning may comprise: applying the same scan pulses and the same address signals to pairs of scan electrodes; and, after applying the scan pulses and the address signals to each pair of the scan electrodes, applying main sustain pulses to one electrode of each pair of scan electrodes, and applying subsidiary sustain pulses to the other electrode of each pair of scan electrodes. The number of subsidiary sustain pulses may be less than the number of main sustain pulses. The pulse width of the subsidiary sustain pulses may be less than the pulse width of the main sustain pulses. Also, the pulse level of the subsidiary sustain pulses may be lower than the pulse level of the main sustain pulses.

According to another aspect of the present invention, there is provided a display panel having a progressive scanning electrode structure. The display panel comprises: a unit that determines an image output mode; a unit that drives the panel by progressive scanning when the image output mode is a first mode; and a unit that drives the panel by interlaced scanning when the image output mode is a second mode. In the latter regard, the first mode may be a monitor mode, and the second mode may be a moving picture mode.

The unit that drives the panel by interlaced scanning may include: a unit that applies the same scan pulses and the same address signals to pairs of scan electrodes; and a unit that applies main sustain pulses to one electrode of each pair of scan electrodes, and applies subsidiary sustain pulses to the other electrode of each pair of scan electrodes, after the scan pulses and the address signals are applied. The number of subsidiary sustain pulses may be less than the number of main sustain pulses. The pulse width of the subsidiary sustain pulses may be less than the pulse width of the main sustain pulses. Also, the pulse level of the subsidiary sustain pulses may be lower than the pulse level of the main sustain pulses.

According to yet another aspect of the present invention, there is provided a panel driving apparatus comprising: a scanning pulse generator that applies the same address pulse to pairs of scan electrodes; a first sustain pulse generator that applies main sustain pulses to a first group of scan electrodes; and a second sustain pulse generator that applies subsidiary sustain pulses to a second group of scan electrodes. Scan electrodes may be divided into the first group and the second group of scan electrodes. Common electrodes may be divided into the first group and the second group of common electrodes. Herein, the number of subsidiary sustain pulses may be less than the number of main sustain pulses. The pulse width of the subsidiary sustain pulses may be less than the pulse width of the main sustain pulses. Also, the subsidiary sustain pulses at a high level may be at a lower voltage than the main sustain pulses at a high level.

The panel driving apparatus may further comprise a first selector that selects one of the first sustain pulse generator and the second sustain pulse generator, and connects the selected generator to even-numbered scan electrodes. The panel driving apparatus may further comprise an image mode determiner that generates an image mode signal according to a variation of an externally input image. The first selector may select one of the first sustain pulse generator and the second sustain pulse generator in response to the image mode signal.

The panel driving apparatus may further comprise a first selector that selects one of the first sustain pulse generator and the second sustain pulse generator and connects the selected generator to even-numbered scan electrodes, and a second selector that selects one of the first sustain pulse generator and the second sustain pulse generator and connects the selected generator to odd-numbered scan electrodes. The panel driving apparatus may further comprise an image mode determiner that generates an image mode signal according to variation of an externally input image. The first selector and the second selector may select one of the first sustain pulse generator and the second sustain pulse generator in response to the image mode signal.

The panel driving apparatus may further comprise an operator that generates an image mode signal by operation of a user. The first selector and/or the second selector may select one of the first sustain pulse generator and the second sustain pulse generator in response to the image mode signal.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows the structure of a typical surface discharge type triode PDP;

FIG. 2 illustrates the operation of a single cell of the PDP shown in FIG. 1;

FIG. 3 shows a typical driving apparatus for the PDP shown in FIG. 1;

FIG. 4 shows a typical address-display separation driving method with respect to Y-electrode lines of the PDP shown in FIG. 1;

FIG. 5 is a timing chart showing examples of driving signals used in the PDP shown in FIG. 1;

FIG. 6 is a diagram of electrodes illustrating a conventional progressive scanning method;

FIG. 7 is a diagram of electrodes illustrating a conventional interlaced scanning method;

FIG. 8 is a flowchart illustrating a panel driving method according to an embodiment of the present invention;

FIG. 9 is a drive waveform diagram illustrating a method of embodying a subsidiary sustain discharge by reducing the number of sustain pulses according to an embodiment of the present invention;

FIG. 10 is a drive waveform diagram illustrating a method of embodying a subsidiary sustain discharge by reducing the number of sustain pulses according to another embodiment of the present invention;

FIG. 11 is a diagram of electrodes obtained when interlaced scanning is performed on a progressive scanning electrode structure according to an embodiment of the present invention, showing the results of implementation of the drive waveforms shown in FIG. 9;

FIG. 12 is a modified example of FIG. 11, which shows the results of implementation of the drive waveforms shown in FIG. 10;

FIG. 13 is a block diagram of a panel driving apparatus according to an embodiment of the present invention;

FIG. 14 is a block diagram of a panel driving apparatus according to another embodiment of the present invention;

FIG. 15 is a schematic construction diagram of a display panel, which can embody the panel driving method according to the present invention; and

FIG. 16 is a modified example of FIG. 15, in which common electrodes are divided into a group of main sustain electrodes and a group of subsidiary sustain electrodes.

### DETAILED DESCRIPTION OF THE INVENTION

Hereinafter, exemplary embodiments of the present invention will be described in detail with reference to the attached drawings. In the present invention, a method of driving an alternating current (AC) type PDP will be mainly described.

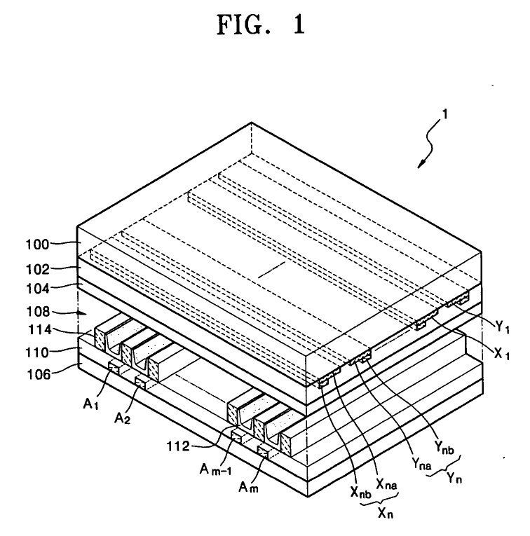

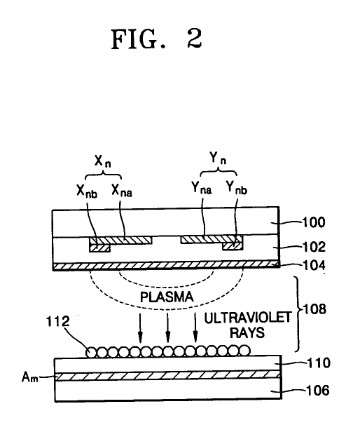

FIG. 1 shows the structure of a typical surface discharge type triode PDP, and FIG. 2 illustrates the operation of a single cell of the PDP shown in FIG. 1.

Referringto FIGS. 1 and 2, address electrode lines A₁, A₂, . . . , Aₘ, dielectric layers 102 and 110, Y-electrode lines Y₁, . . . , Yₙ, X-electrode lines X₁, . . . , Xₙ, phosphor layers 112, barrier walls 114, and a protective layer 104, for example, a magnesium oxide (MgO) layer, are provided between a front glass substrate 100 and a rear glass substrate 106 of the surface discharge PDP 1.

The address electrode lines A₁ through Aₘ are formed on the front surface of the rear glass substrate 106 in a predetermined pattern. A rear dielectric layer 110 is formed on the surface of the rear glass substrate 106 having the address electrode lines A₁ through Aₘ. The barrier walls 114 are formed on the front surface of the rear dielectric layer 110 parallel to the address electrode lines A₁ through Aₘ. The barrier walls 114 partition discharge regions of respective display cells and serve to prevent cross talk between display cells. The phosphor layers 112 are formed between the barrier walls 114.

The X-electrode lines X₁ through Xₙ and the Y-electrode lines Y₁ through Yₙ are formed on the rear surface of the front glass substrate 100 in a predetermined pattern so as to be orthogonal to the address electrode lines A₁ through Aₘ. The respective intersections define display cells. Each of the X-electrode lines X₁ through Xₙ may include a transparent electrode line Xₙₐ formed of a transparent conductive material, e.g., indium tin oxide (ITO), and a metal electrode line X_{nb} for increasing conductivity. Each of the Y-electrode lines Y₁, Y₂, . . . , Yₙ may include a transparent electrode line Yₙₐ formed of a transparent conductive material, e.g., indium tin oxide (ITO), and a metal electrode line Y_{nb} for increasing conductivity. A front dielectric layer 102 is deposited on the entire rear surface of the front glass substrate 100 having the X-electrode lines X₁, X₂, . . . , Xₙ and the Y-electrode lines Y₁, Y₂, . . . , Yₙ formed on its rear surface. The protective layer 104, e.g., a MgO layer, for protecting the panel 1 against a strong electrical field, is deposited on the entire rear surface of the front dielectric layer 102. A gas for forming plasma is hermetically sealed in a discharge space 108.

In driving such a PDP, usually, a reset step, an address step, and a sustain step are sequentially performed in each subfield. In the reset step, charges are made uniform in display cells to be driven. In the address step, a charge state of display cells to be selected and a charge state of display cells to be unselected are set up. In the sustain step, a display discharge is performed in the display cells to be selected. In the latter regard, plasma is produced from the plasma forming gas in the display cells where the display discharge is performed. The plasma emits ultraviolet rays exciting the phosphor layers 112 in the display cells so that light is emitted.

An address-display separation driving method for the PDP 1 having such a structure is disclosed in U.S. Pat. No. 5,541,618.

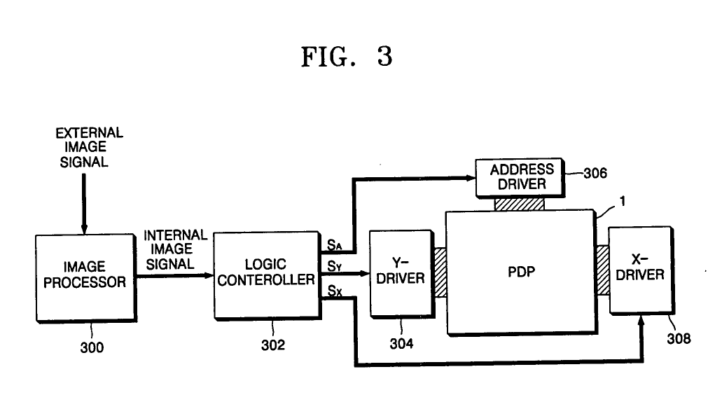

FIG. 3 shows a typical driving apparatus for the PDP shown in FIG. 1. Referring to FIG. 3, the typical driving apparatus for the PDP 1 includes an image processor 300, a logic controller 302, an address driver 306, an X-driver 308, and a Y-driver 304. The image processor 300 converts an external analog image signal into a digital signal to generate an internal image signal, for example, 8-bit red (R) video data, 8-bit green (G) video data, and 8-bit blue (B) video data, a clock signal, a vertical synchronizing signal, and a horizontal synchronizing signal. The logic controller 302 generates drive control signals S_{A}, S_{Y}, and S_{X} in response to the internal image signals from the image processor 300. The address driving unit 306 processes the address signal S_{A} among the drive control signals S_{A}, S_{Y}, and S_{X} output from the logic controller 302 to generate a display data signal, and applies the display data signal to address electrode lines. The X-driver 308 processes the X-drive control signal S_{X} among the drive control signals S_{A}, S_{Y}, and S_{X} output from the logic controller 302, and applies the result of processing to X-electrode lines. The Y-driver 304 processes the Y-drive control signal S_{Y} among the drive control signals S_{A}, S_{Y}, and S_{X} output from the logic controller 302, and applies the result of processing to Y-electrode lines.

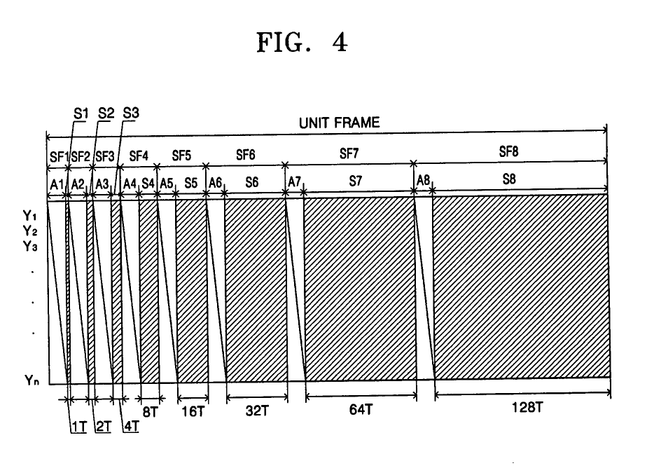

FIG. 4 shows a typical address-display separation driving method with respect to Y-electrode lines of the PDP 1 shown in FIG. 1. Referring to FIG. 4, to realize time-division grayscale display, a unit frame may be divided into a predetermined number of subfields, e.g., 8 subfields SF1, SF2, . . . , SF8. In addition, the individual subfields SF1 through SF8 are composed ofreset periods (not shown), respectively, address periods A1, A2, . . . , A8, and sustain periods S1, S2, . . . , S8, respectively.

During each of the address periods A₁ through A₈, display data signals are applied to address electrode lines A₁ through A₈ of FIG. 1 and, simultaneously, a scan pulse is sequentially applied to the Y-electrode lines Y₁ through Yₙ.

During each of the sustain periods S₁ through S₈, a pulse for display discharge is alternately applied to the Y-electrode lines Y₁ through Yₙ and the X-electrode lines X₁ through Xₙ, thereby provoking display discharge in discharge cells in which wall charges are induced during each of the address periods A₁ through A₈.

The luminance of the PDP 1 is proportional to a total length of the sustain periods S1 through S8 in a unit frame. When a unit frame forming a single image is expressed by 8 subfields and 256 grayscales, different numbers of sustain pulses may be allocated to the respective subfields at a ratio of 1:2:4:8:16:32:64:128. Luminance corresponding to 133 grayscales can be obtained by addressing cells and sustaining a discharge during a first subfield SF1, a third subfield SF3, and an eighth subfield SF8.

A sustain period allocated to each subfield can be variably determined depending upon weights, which are applied to the respective subfields according to an automatic power control (APC) level, and can be variously changed taking account of gamma characteristics or panel characteristics. For example, a grayscale level allocated to a fourth subfield SF4 can be lowered from 8 to 6, while a grayscale level allocated to a sixth subfield SF6 can be increased from 32 to 34. In addition, the number of subfields constituting a single frame can be variously changed according to design specifications.

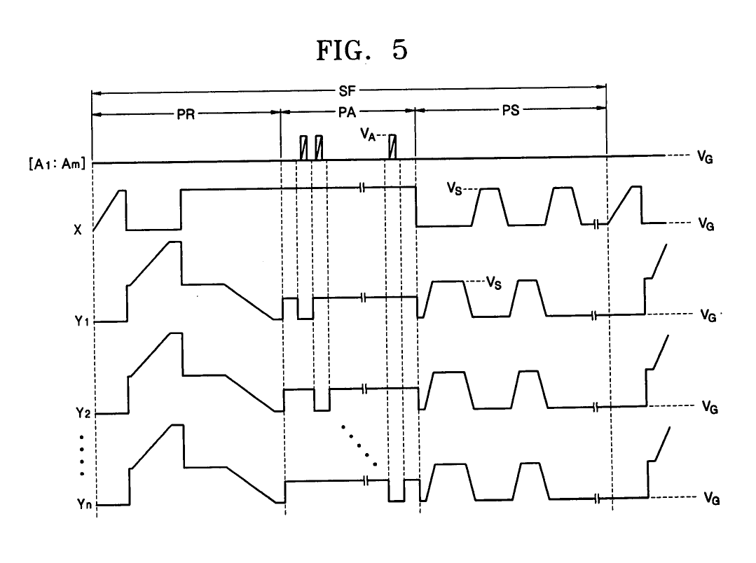

FIG. 5 is a timing chart showing examples of driving signals used in the PDP 1 shown in FIG. 1. In other words, FIG. 5 illustrates driving signals applied to address electrodes A₁ through Aₘ, common electrodes X, and scan electrodes Y₁ through Yₙ during a single subfield SF in an address display separated (ADS) driving method of an alternating current (AC) PDP. Referring to FIG. 5, the single subfield SF includes a reset period PR, an address period PA, and a sustain period PS.

During the reset period PR, a reset pulse is applied to all of the scan electrodes Y₁ through Yₙ, thereby initializing a state of wall charges in each cell. The reset period PR is performed before entering the address period PA. The reset period PR is provided prior to the address period PA. Since the initialization is performed throughout the PDP1 during the reset period PR, a highly uniform and desirable distribution of wall charges can be obtained. The cells initialized during the reset period PR have wall charge conditions similar to one another. The reset period PR is followed by the address period PA. During the address period PA, a bias voltage Vₑ is applied to the common electrodes X, and the scan electrodes Y₁ through Yₙ and the address electrodes A₁ through Aₘ corresponding to cells to be displayed are simultaneously turned on to select the cells. After the address period PA, a sustain pulse V_{S} is alternately applied to the common electrodes X and the scan electrodes Y₁ through Yₙ during the sustain period PS. During the sustain period PS, a voltage V_{G} of a low level is applied to the address electrodes A₁ through Aₘ.

In a PDP, luminance is adjusted by the number of sustain pulses. As the number of sustain pulses in a single subfield or TV field increases, the luminance also increases. Thus, a time period taken for a sustain period should be lengthened in order to increase the luminance. However, since a period of a first TV field is fixed to, for example, 60 Hz and 16.67 ms, in driving the PDP, the reset period and the address period should be shortened or the subfield should be reduced in order to increase the sustain period.

The time taken for an address operation significantly affects the high definition of a PDP. In other words, address times are allocated to respective scan lines. A PDP of a higher definition requires a greater number of scan lines. Then, when the address speed is constant, the address time is increased in proportion to the number of scan lines. Consequently, the period for allocating a sustain discharge in a fixed TV field is reduced.

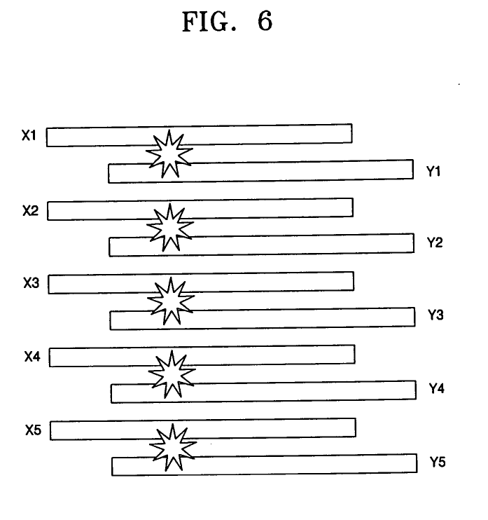

FIG. 6 is a diagram of electrodes illustrating a conventional progressive scanning method. A single scan electrode and a single sustain electrode are required for each pixel to drive a triode AC PDP, as shown in FIG. 6. However, an address electrode is not shown in FIG. 6.

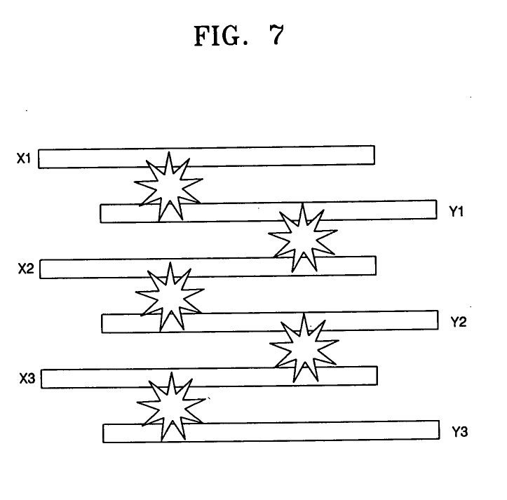

FIG. 7 is a diagram of electrodes illustrating a conventional interlaced scanning method. While progressive scanning requires N scan electrodes and N common electrodes as illustrated in FIG. 6, interlaced scanning requires only N+1 electrodes. In the interlaced scanning method, a panel is driven by separating an odd-numbered address period from an even-numbered address period. During the odd-numbered address period, a sustain discharge is induced between X1 and Y1, X2 and Y2, and X3 and Y3. During the even-numbered address period, a sustain discharge is generated between Y1 and X2 and Y2 and X3. Thus, a single picture is formed by adding the odd-numbered address period, the sustain discharge period, the even-numbered address period, and the sustain discharge period.

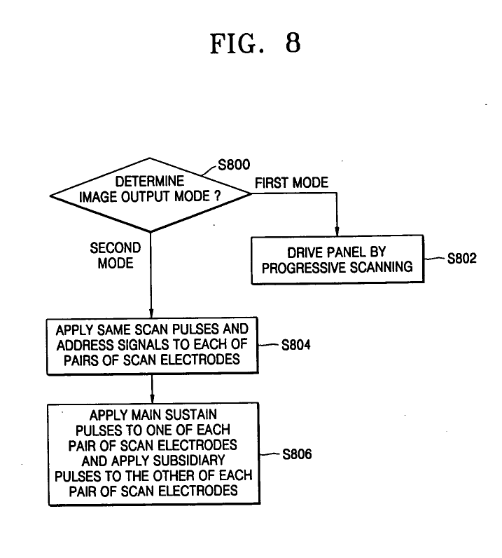

FIG. 8 is a flowchart illustrating a panel driving method according to an embodiment of the present invention. The panel driving method shown in FIG. 8 is applicable to a display panel having a progressive scanning electrode structure.

Specifically, at the outset, an image output mode is determined in step S800.

If the determination is a first mode, a panel is driven by progressive scanning in step S802.

If the determination is a second mode, the panel is driven by interlaced scanning in steps S804 and S806. The interlaced scanning is not applied to a panel structure suitable for interlacing scanning as shown in FIG. 7. In the present invention, to drive a display panel having a progressive scanning electrode structure, a new interlaced scanning method using a main sustain discharge and a subsidiary sustain discharge is proposed.

When the image output mode is the second mode, two scan electrodes are grouped into a pair, and the same scan pulses are applied to each pair of scan electrodes in step S804.

Thereafter, main sustain pulses are applied to one electrode of each pair of scan electrodes, and subsidiary sustain pulses are applied to the other electrode of each pair of scan electrodes in step S806.

For example, if the same address signals and the same sustain pulses are applied to pairs of scan electrodes in step 804, the resolution is reduced to half.

In step S806, a main sustain discharge and a subsidiary sustain discharge are separately used.

The main sustain discharge is a sustain discharge inducing strong emission equivalent (for example) to a sustain discharge caused by conventional progressive scanning. A subsidiary sustain discharge is a sustain discharge including weaker emission than the main sustain discharge.

Meanwhile, the first mode may be a monitor mode, and the second mode may be a moving picture mode.

When a display panel operates as a monitor that is connected to a computer, as an image of a low variation rate is generally output, it is preferable that high definition is visibly embodied but luminance is relatively low.

When a display panel displays a moving picture as an image of a high variation rate is output, luminance characteristics are importantly considered. The luminance of a PDP can be improved by increasing time allocated to sustain a discharge. Thus, it is necessary to reduce time taken for a scan operation and to allocate a larger amount of time in order to sustain a discharge.

Accordingly, in the first mode, i.e., the monitor mode, the progressive scanning method is used to realize high definition, whereas in the second mode, i.e., the moving picture mode, the interlaced scanning method is used to enhance luminance.

The number of subsidiary sustain pulses may be less than the number of main sustain pulses.

For example, odd-numbered electrodes may be designated as main sustain electrodes and even-numbered electrodes may be designated as subsidiary sustain electrodes, and sustain pulses may be applied to the main and subsidiary sustain electrodes. As a result, the main sustain electrodes emit strong light, while the subsidiary sustain electrodes emit weak light.

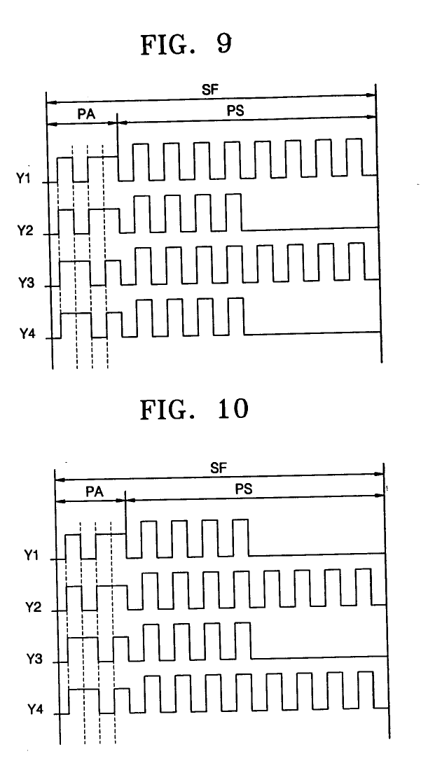

FIGS. 9 and 10 are exemplary drive waveform diagrams illustrating a method of embodying a subsidiary sustain discharge by reducing the number of sustain pulses.

Referring to FIG. 9, in a single subfield, during an address period PA, the same scan pulses are applied to scan electrodes Y1 and Y2, and the same scan pulses are applied to scan electrodes Y3 and Y4. Accordingly, step S804 of FIG. 8 is carried out. Next, during a sustain period PS, sustain pulses are applied to odd-numbered scan electrodes Y1 and Y3 until an end point of an allocated subfield, and sustain pulses are applied to even-numbered scan electrodes Y2 and Y4 in a number less than the sustain pulses applied to the odd-numbered scan electrodes Y1 and Y3. Accordingly, the same data is displayed for every two scan electrodes, so that strong emission is induced in odd-numbered display cells and weak emission is induced in even-numbered display cells. Here, the odd-numbered scan electrodes correspond to main sustain electrodes, and the even-numbered scan electrodes correspond to subsidiary sustain electrodes.

FIG. 10 is a modified example of FIG. 9, in which main sustain pulses are applied to even-numbered scan electrodes and subsidiary sustain pulses are applied to odd-numbered scan electrodes.

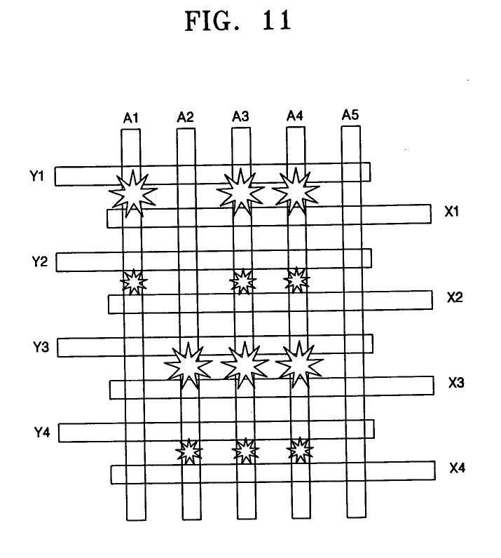

FIG. 11 is a diagram of electrodes obtained when interlaced scanning is performed on a progressive scanning electrode structure according to an embodiment of the present invention. In other words, FIG. 11 shows the results of implementing the drive waveforms shown in FIG. 9.

Referring to FIG. 11, scan electrodes Y1 and Y2 are addressed and displayed at the same time during address periods A1, A2, and A3. However, the main sustain electrode YI emits a stronger light than light emitted by the subsidiary sustain electrode Y2. Likewise, although the scan electrodes Y3 and Y4 are addressed and displayed at the same time during address periods A2, A3, and A4, the main sustain electrode Y3 emits stronger light than light emitted by the subsidiary sustain electrode Y4.

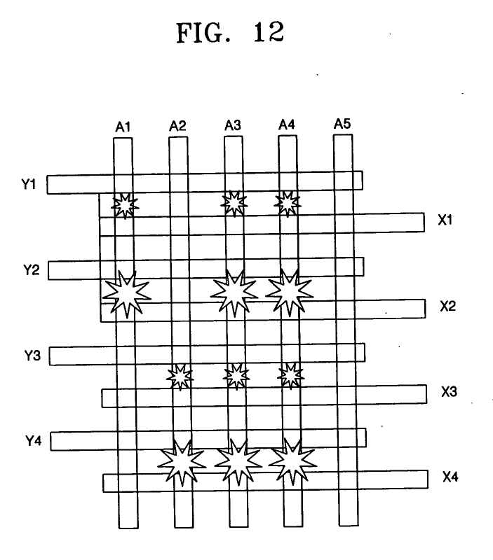

FIG. 12 is a modified example of FIG. 11, which shows the results of implementing the drive waveforms shown in FIG. 10.

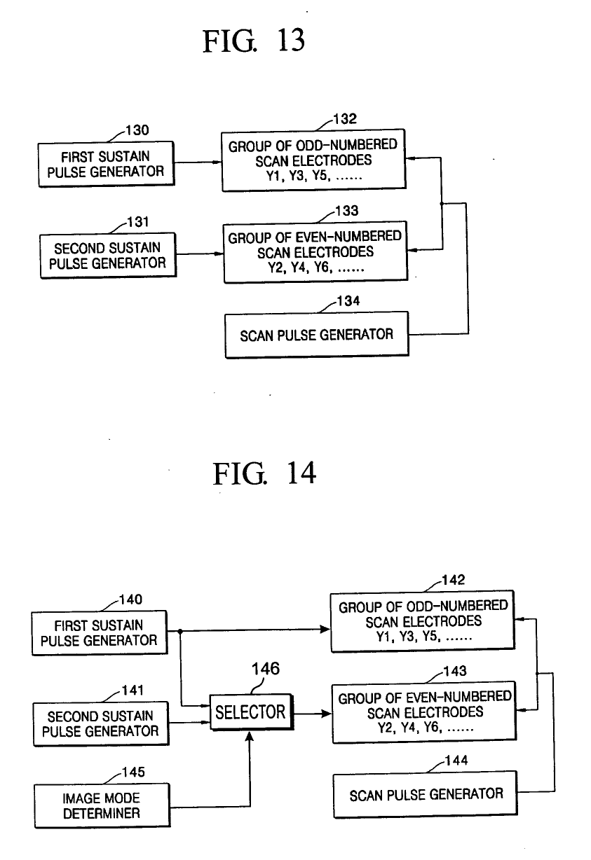

FIG. 13 is a block diagram of a panel driving apparatus according to an embodiment of the present invention. The panel driving apparatus includes a first sustain pulse generator 130, a second sustain pulse generator 131, a group 132 of odd-numbered scan electrodes, a group 133 of even-numbered scan electrodes, and a scan pulse generator 134. FIG. 13 shows a panel driving apparatus for driving a display panel having a progressive scanning electrode structure by interlaced scanning.

The scan pulse generator 134 applies the same scan pulses to each of pairs of scan electrodes. The first sustain pulse generator 130 generates main sustain pulses, and the second sustain pulse generator 131 generates subsidiary sustain pulses.

FIG. 14 is a block diagram of a panel driving apparatus according to another embodiment of the present invention. The panel driving apparatus includes a first sustain pulse generator 140, a second sustain pulse generator 141, a group 142 of odd-numbered scan electrodes, a group 143 of even-numbered scan electrodes, a scan pulse generator 144, an image mode determiner 145, and a selector 146.

The scan pulse generator 144 applies the same scan pulses to each pair of scan electrodes. The first sustain pulse generator 140 generates main sustain pulses, and the second sustain pulse generator 141 generates subsidiary sustain pulses. The selector 146 connects the first sustain pulse generator 140 to the group 143 of even-numbered scan electrodes to enable progressive scanning when, for example, the monitor mode is determined in the image mode determiner 145. The selector 146 connects the second sustain pulse generator 141 to the group 143 of even-numbered scan electrodes 143 to enable interlaced scanning.

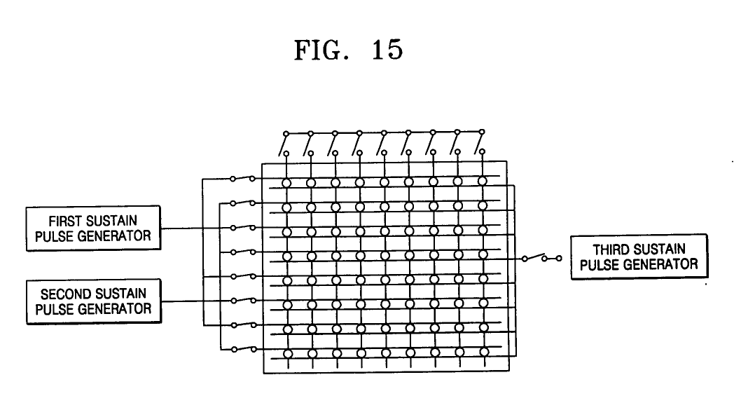

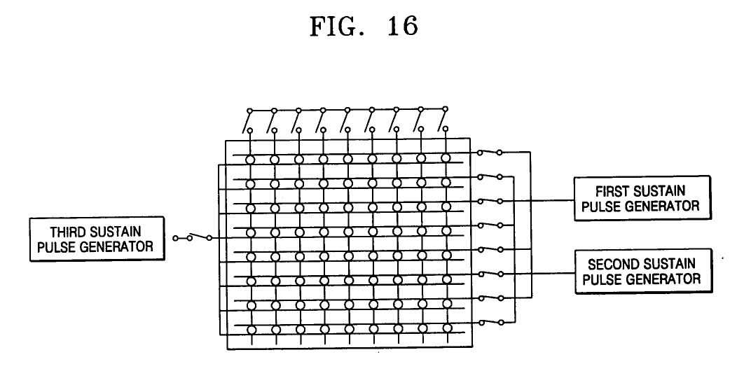

FIG. 15 is a schematic construction diagram of a display panel, which can realize the panel driving method according to the present invention. Referring to FIG. 15, to realize an interlaced scanning method, scan electrodes are divided into a group of main sustain electrodes and a group of subsidiary sustain electrodes, which are driven by a first sustain pulse generator and a second sustain pulse generator, respectively. In the monitor mode in which progressive scanning is applied, the first sustain pulse generator and the second sustain pulse generator output the same sustain signals.

FIG. 16 shows a modified example of FIG. 15, in which common electrodes are divided into a group of main sustain electrodes and a group of subsidiary sustain electrodes.

In driving electrodes of the PDP, an address period in which a cell for emitting light is selected, and a sustain period in which the selected cell emits light, are sequentially performed. In addition, the panel driving method of present invention can be applied to any display apparatus requiring initialization of cells. For example, it is obvious to those skilled in the art that the technology of the present invention can be applied not only to an AC PDP but also to direct current (DC) PDPs, electroluminescence displays (ELD), and liquid crystal displays (LCD).

The invention can also be embodied as computer readable codes on a computer readable recording medium. The computer readable recording medium is any data storage device that can store programs or data which can be read thereafter by a computer system. Examples of the computer readable recording medium include read-only memory (ROM), random-access memory (RAM), CD-ROMs, magnetic tapes, floppy disks, and optical data storage devices. In this case, the programs stored in the recording medium are expressed by a series of instructions that are directly or indirectly used in devices having information processing capability, such as a computer, to obtain specific results. Accordingly, the term “computer” refers to any kind of device, which includes an input unit, an output unit, and an arithmetic unit, and which has information processing capability for performing specific functions. A panel driving apparatus can be a kind of computer even if it is limited to a specific field of a panel drive.

In particular, the panel driving method of the present invention is written by schematic or VHSIC hardware description language (VHDL) on a computer, and can be connected to a computer and embodied by a programmable integrated circuit (IC), e.g., field programmable gate array (FPGA). The recording medium includes this programmable IC.

As described above, in the panel driving method, a variable reset period is applied according to the length of a pause period in a single TV field, so that a reset operation for preparing an address period is stably performed.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A panel driving method for driving a display panel having a progressive scanning electrode structure, the method comprising:
determining an image output mode;
driving the display panel by progressive scanning when it is determined that the image output mode is a first mode; and
driving the display panel by interlaced scanning when it is determined that the image output mode is a second mode.

2. The panel driving method of claim 1, wherein the first mode is a monitor mode, and the second mode is a moving picture mode.

3. The panel driving method of claim 1, wherein the interlaced scanning comprises:
applying the same scan pulses and the same address signals to pairs of scan electrodes; and
after applying the scan pulses and the address signals to each pair of the scan electrodes, applying main sustain pulses to one electrode of each pair of the scan electrodes and applying subsidiary sustain pulses to another electrode of each pair of the scan electrodes.

4. The panel driving method of claim 3, wherein a number of the subsidiary sustain pulses is less than a number of the main sustain pulses.

5. A display panel having a progressive scanning electrode structure, the display panel comprising:
means for determining an image output mode;
means for driving the display panel by progressive scanning when it is determined that the image output mode is a first mode; and
means for driving the display panel by interlaced scanning when it is determined that the image output mode is a second mode.

6. The display panel of claim 5, wherein the first mode is a monitor mode, and the second mode is a moving picture mode.

7. The display panel of claim 5, wherein the means for driving the display panel by the interlaced scanning comprises:
a unit applying the same scan pulses and the same address signals to pairs of scan electrodes; and
a unit applying main sustain pulses to one electrode of each pair of the scan electrodes and applying subsidiary sustain pulses to another electrode of each pair of the scan electrodes after the scan pulses and the address signals are applied.

8. The display panel of claim 7, wherein a number of the subsidiary sustain pulses is less than a number of the main sustain pulses.

9. A panel driving apparatus comprising:
a scanning pulse generator for applying the same address pulse to pairs of scan electrodes;
a first sustain pulse generator for applying main sustain pulses to a first group of scan electrodes; and
a second sustain pulse generator for applying subsidiary sustain pulses to a second group of scan electrodes.

10. The panel driving apparatus of claim 9, further comprising common electrodes which are divided into a first group of common electrodes and a second group of common electrodes.

11. The panel driving apparatus of claim 9, wherein a number of the subsidiary sustain pulses is less than a number of the main sustain pulses.

12. The panel driving apparatus of claim 9, further comprising a first selector for selecting one of the first sustain pulse generator and the second sustain pulse generator, and for connecting the selected sustain pulse generator to even-numbered scan electrodes.

13. The panel driving apparatus of claim 12, further comprising an image mode determiner for generating an image mode signal according to variation of an externally input image; and
wherein the first selector selects one of the first sustain pulse generator and the second sustain pulse generator in response to the image mode signal.

14. The panel driving apparatus of claim 12, further comprising a second selector for selecting one of the first sustain pulse generator and the second sustain pulse generator, and for connecting the selected sustain pulse generator to odd-numbered scan electrodes.

15. The panel driving apparatus of claim 14, further comprising an image mode determiner for generating an image mode signal according to variation of an externally input image; and
wherein the first selector and the second selector select one of the first sustain pulse generator and the second sustain pulse generator in response to the image mode signal.

16. The panel driving apparatus of claim 14, further comprising operator means for generating an image mode signal by means of operation of a user;
wherein at least one of the first selector and the second selector selects one of the first sustain pulse generator and the second sustain pulse generator in response to the image mode signal.

17. A computer readable medium having stored thereon a computer program for driving a display panel having a progressive scanning electrode structure, said computer program containing instructions for:
determining an image output mode;
driving the display panel by progressive scanning when it is determined that the image output mode is a first mode; and
driving the display panel by interlaced scanning when it is determined that the image output mode is a second mode.

18. The computer readable medium of claim 17, wherein the first mode is a monitor mode, and the second mode is a moving picture mode.

19. The computer readable medium of claim 17, wherein the interlaced scanning comprises:
applying the same scan pulses and the same address signals to pairs of scan electrodes; and
after applying the scan pulses and the address signals to each pair of the scan electrodes, applying main sustain pulses to one electrode of each pair of the scan electrodes and applying subsidiary sustain pulses to another electrode of each pair of the scan electrodes.

20. The computer readable medium of claim 19, wherein a number of the subsidiary sustain pulses is less than a number of the main sustain pulses.
